(19) United States
(12) Patent Application Publication
(10) Pub. No.: US 2026/0302477 A1
(43) Pub. Date: Oct. 1, 2026

(54) BATTERY MODULE

(71) Applicant: HONDA MOTOR CO., LTD., Tokyo (JP)

(72) Inventor: Tatsuya SEKI, Saitama (JP)

(21) Appl. No.: 19/577,804

(22) Filed: Mar. 25, 2026

(30) Foreign Application Priority Data
Mar. 31, 2025 (JP) 2025-058729

(51) Int. Cl. H01M 50/242; H01M 10/0525; H01M 50/204; H01M 50/291

(52) U.S. Cl. CPC H01M 50/242; H01M 10/0525; H01M 50/204; H01M 50/291

(57) ABSTRACT

Provided is a battery module including corrugated leaf springs. The corrugated leaf spring includes curved surface parts contiguously arranged with a flat surface part therebetween, and extends in a predetermined direction, and the curved surface parts each have an identical curvature radius. The flat surface part has a surface approximately parallel to a tangent plane in an end part of the curved surface part, the end part being arranged contiguous to the flat surface part. Provided that the curved surface parts each have a curvature radius of r [mm], and that, when a pitch of the curved surface parts and a height are not changed in the corrugated leaf spring and the curved surface parts each having an identical curvature radius are alternately and contiguously arranged without the flat surface part therebetween, the curved surface parts each have a curvature radius of r₀ [mm], the following formula is satisfied: 0.50≤r/r₀≤0.90.

This application is based on and claims the benefit of priority from Japanese Patent Application No. 2025-058729, filed on 31 March 2025, the content of which is incorporated herein by reference.

### BACKGROUND OF THE INVENTION

### Field of the Invention

The present invention relates to a battery module.

### Related Art

In recent years, research and development concerning battery modules that contribute to energy efficiency has been conducted to enable many people to access affordable, reliable, sustainable, and advanced energy.

Since battery cells expand and contract during charge and discharge, battery modules include, for example, a pair of end plates provided on opposite ends of a battery cell stack in a stacking direction, and a bind bar that binds the battery cell stack between the pair of end plates.

Japanese Unexamined Patent Application, Publication No. 2024-066882 discloses a spacer for a battery which is arranged between two battery cells facing each other. Here, the spacer for a battery includes: a base body having a corrugated cross-sectional shape in which peaks and valleys continue and having a peak-side surface as a surface facing one of the two battery cells and a valley-side surface as a surface facing the other; pressure receiving surfaces that are located at tops of the corrugated shape of the base body and are in surface contact with the two battery cells, the tops appearing on the peak-side surface and the valley-side surface respectively; and a buffer that alternately connects the pressure receiving surfaces located on the peak-side surface and the valley-side surface to form the corrugated shape. The buffer gives alternately, to the corrugated shape, a barrel shape having a width increasing from opposite ends of the pressure receiving surface, reaching a maximum width at a buckling-allowing bent part, and then decreasing, and provides an arrangement interval between bent parts adjacent to each other on the same surface side to ensure an arrangement space for buckled bent parts.

Patent Document 1: Japanese Unexamined Patent Application, Publication No. 2024-066882

### SUMMARY OF THE INVENTION

However, the spacer for a battery which is disclosed in Japanese Unexamined Patent Application, Publication No. 2024-066882 has a predetermined height at the time of being compressed due to expansion of the battery cell during charge, and hence, energy density of the battery during charge decreases.

An object of the present invention is to provide a battery module capable of improving energy density during charge.

(1) A battery module including: a battery cell stack including a plurality of battery cells that are stacked together; a pair of plate-shaped members provided on opposite ends of the battery cell stack in a stacking direction; and an elastic member arranged between the plurality of battery cells and/or between the battery cell stack and the plate-shaped member. The elastic member includes a pair of first elastic members arranged on opposite outer sides of the battery cell stack in the stacking direction and a second elastic member arranged between the pair of first elastic members. The second elastic member includes 2N layers (N: a natural number) of corrugated leaf springs stacked in the stacking direction of the battery cell stack. The corrugated leaf spring includes curved surface parts contiguously arranged with a flat surface part therebetween, and extends in a predetermined direction, the curved surface parts having an identical curvature radius. The flat surface part has a surface approximately parallel to a tangent plane in an end part of the curved surface part, the end part being arranged contiguous to the flat surface part. Provided that the curved surface parts each have a curvature radius of r [mm], and that, when a pitch of the curved surface parts and a height are not changed in the corrugated leaf spring and the curved surface parts each having an identical curvature radius are alternately and contiguously arranged without the flat surface part therebetween, the curved surface parts each have a curvature radius of r₀ [mm], the following formula is satisfied:

0.50≤r/r₀≤0.90.

(2) In the battery module according to (1), the following formula is satisfied:

0.60≤r/r₀≤0.85.

(3) In the battery module according to (2), the following formula is satisfied:

0.70≤r/r₀≤0.80.

(4) In the battery module according to any one of (1) to (3), the second elastic member is in contact with the first elastic member at a plurality of contact areas present in a width direction, the corrugated leaf spring contacting at the contact areas includes an extension extending outward in the width direction from the contact area present at an outermost part of the corrugated leaf spring in the width direction, and as a distance in the width direction from the contact area present at the outermost part in the width direction to the extension increases, a distance in a thickness direction from the first elastic member contacting at the contact area to the extension increases.

(5) In the battery module according to (4), in the corrugated leaf spring contacting at the contact areas, a length in the width direction between a top or a bottom of the curved surface part adjacent to an end part of the extension and the end part of the extension is larger than a length in the width direction between a bottom and a top of the curved surface parts adjacent to each other.

(6) In the battery module according to any one of (1) to (5), the corrugated leaf spring includes fiber reinforced plastic.

(7) In the battery module according to any one of (1) to (6), the battery cells are solid-state battery cells.

(8) In the battery module according to any one of (1) to (7), the battery cells include a negative electrode mixture layer containing a lithium metal or lithium alloy.

According to the present invention, it is possible to provide a battery module capable of improving energy density during charge.

### BRIEF DESCRIPTION OF THE DRAWINGS

FIG. 1 is a cross sectional view showing a battery module according to one embodiment of the present invention;

FIG. 2 is a cross sectional view showing an elastic member in FIG. 1;

FIG. 3 is a cross sectional view showing a part of a corrugated leaf spring in FIG. 2;

FIG. 4 is a cross sectional view illustrating a case where a flat surface part is not provided without changing a height and a curved surface part pitch in the corrugated leaf spring in FIG. 3;

FIG. 5 is a graph showing relationship between surface pressure and a ratio (h/h₀) of a height h when predetermined surface pressure is applied to corrugated leaf springs of an experiment example 1 and comparison experiment examples 1 and 2, to a height h₀ when surface pressure of the corrugated leaf springs is 0 MPa;

FIG. 6A is a cross sectional view showing the corrugated leaf spring of the experiment example 1;

FIG. 6B is a cross sectional view showing the corrugated leaf spring of the comparison experiment example 1;

FIG. 6C is a cross sectional view showing the corrugated leaf spring of the comparison experiment example 2;

FIG. 7 is a graph showing relationship between r/r₀ and h/h₀ at a surface pressure of 2.5 MPa of the corrugated leaf spring;

FIG. 8 is a partially enlarged cross sectional view of the elastic member in FIG. 2;

FIG. 9 is a cross sectional view showing the corrugated leaf spring in FIG. 2;

FIG. 10A is a cross sectional view illustrating a method for manufacturing the elastic member in FIG. 2; and

FIG. 10B is a cross sectional view illustrating the method for manufacturing the elastic member in FIG. 2.

### DETAILED DESCRIPTION OF THE INVENTION

Hereinafter, an embodiment of the present invention will be described with reference to drawings.

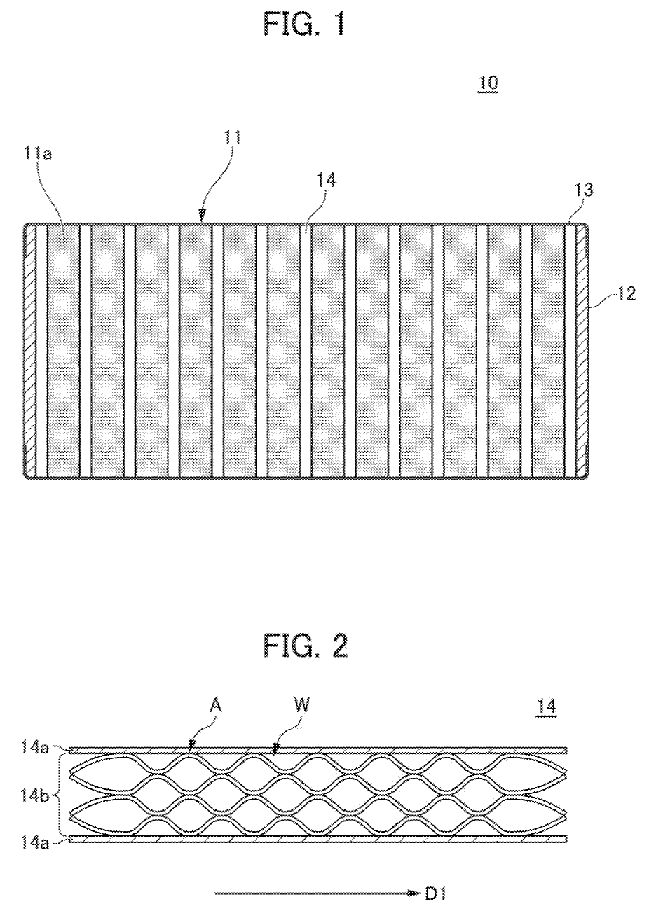

FIG. 1 shows a battery module according to one embodiment of the present invention.

A battery module 10 includes a battery cell stack 11 in which a plurality of battery cells 11a are stacked, end plates 12 as a pair of plate-shaped members provided on opposite ends of the battery cell stack 11 in a stacking direction, and a bind bar 13 as a binding member that binds the battery cell stack 11 between the pair of end plates 12. Here, the bind bar 13 is provided in each of two locations of upper and lower parts in the drawing, respectively.

In the battery module 10, elastic members 14 are arranged between the plurality of battery cells 11a and between the battery cell stack 11 and the end plate 12, respectively.

Alternatively, the elastic member 14 may be arranged between the plurality of battery cells 11a or between the battery cell stack 11 and the end plate 12.

As shown in FIG. 2, the elastic member 14 includes a pair of first elastic members 14a arranged on opposite outer sides of the battery cell stack 11 in the stacking direction, and a second elastic member 14b arranged between the pair of first elastic members 14a. As the second elastic member 14b, four layers of corrugated leaf springs W are stacked in the stacking direction of the battery cell stack 11. Consequently, hysteresis loss of the elastic member 14 is reduced. In this case, the second elastic member 14b is in contact with the first elastic member 14a at a plurality of contact areas A present in a width direction D1.

Here, when the elastic member 14 is compressed due to expansion of the battery cell 11a during charge, the first elastic member 14a is present between the battery cell 11a and the second elastic member 14b, and hence a difference in surface pressure decreases between a portion of the first elastic member 14a which is in contact with the second elastic member 14b and a portion of the first elastic member 14a which is not in contact with the second elastic member 14b; thus, uniformity of the surface pressure increases.

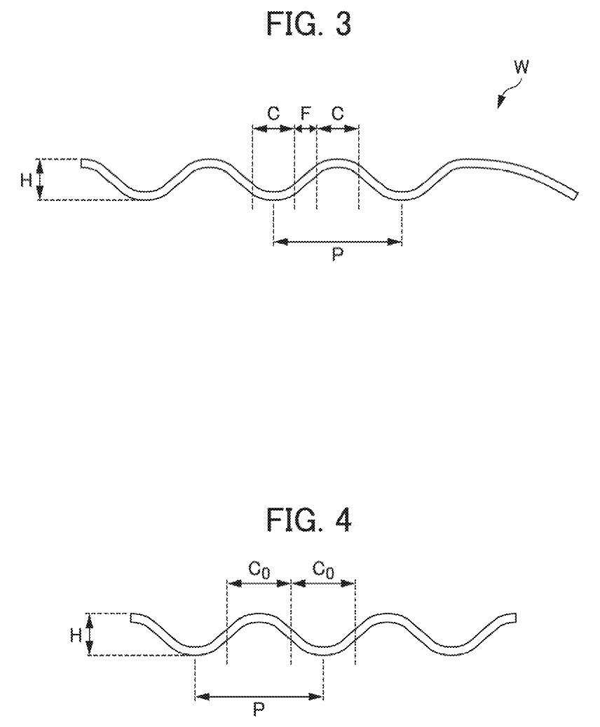

The corrugated leaf spring W includes, as shown in FIG. 3, curved surface parts C each of which has an identical curvature radius and which are contiguously arranged with a flat surface part F provided therebetween, and the corrugated leaf spring W extends in a depth direction in the drawing. In this case, a surface of the flat surface part F is approximately parallel, and preferably parallel, to a tangent plane in an end part of the curved surface part C which is contiguous to the flat surface part F. Further, a bottom of the curved surface part C of the corrugated leaf spring W and a top of the curved surface part C of an adjacent corrugated leaf spring W face each other and are in contact with each other. Note that the bottom and the top of the curved surface parts C are present in the curved surface parts C that are projecting downward and upward in the stacking direction of the battery cell stack 11, respectively.

Provided that the curved surface parts C each have a curvature radius of r [mm], and that, when the flat surface part F is not provided without changing a pitch P of the curved surface parts C and a height H in the corrugated leaf spring W, namely, when curved surface parts C₀ each having an identical curvature radius are alternately and contiguously arranged (see FIG. 4), the curved surface parts C₀ each have a curvature radius of r₀ [mm], a formula

0.50≤r/r₀≤0.90

is satisfied, a formula

0.60≤r/r₀≤0.85

is preferably satisfied, and a formula

0.70≤r/r₀≤0.80

is preferably satisfied. Since r/r₀ is greater than or equal to 0.5 and less than or equal to 0.9, when the elastic member 14 is compressed due to expansion of the battery cell 11a during charge, the height of the corrugated leaf spring W is decreased; as a result, energy density of the battery module 10 during charge increases. In this case, H is, for example, greater than or equal to 1.0 mm and less than or equal to 3.0 mm, although not particularly limited. Further, P is, for example, greater than or equal to 6.0 mm and less than or equal to 16.0 mm, although not particularly limited. Furthermore, r₀ is, for example, greater than or equal to 3.0 mm and less than or equal to 7.0 mm, although not particularly limited. A thickness of each of the flat surface part F and the curved surface part C, namely, a thickness of the corrugated leaf spring W, is, for example, greater than or equal to 0.1 mm and less than or equal to 0.55 mm, although not particularly limited.

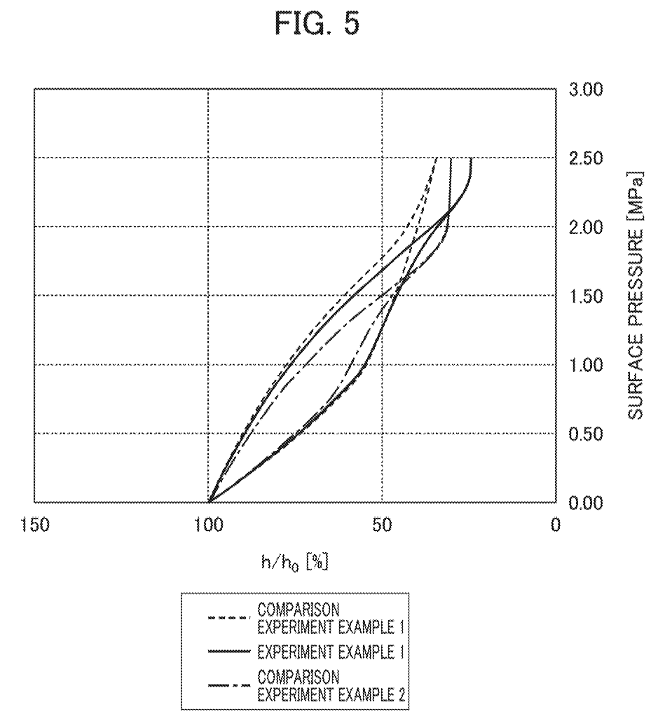

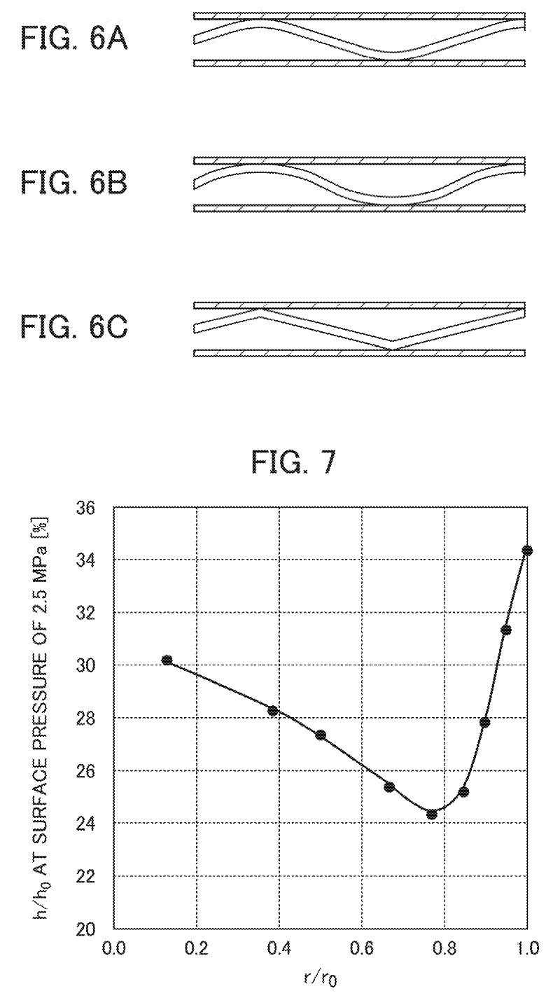

FIG. 5 shows relationship between surface pressure and a ratio (h/h₀) of a height h when predetermined surface pressure is applied to corrugated leaf springs to a height h₀ when surface pressure of the corrugated leaf springs is 0 MPa. Here, in the corrugated leaf spring of an experiment example 1, curved surface parts C each having an identical curvature radius are contiguously arranged with a flat surface part F provided therebetween (see FIG. 6A). The corrugated leaf spring of the experiment example 1 is made of glass fiber reinforced plastic. The corrugated leaf spring of a comparison experiment example 1 is a corrugated leaf spring in which the flat surface part F is not provided without changing a pitch P of the curved surface parts C and a height H in the corrugated leaf spring of the experiment example 1 (see FIG. 6B). Further, the corrugated leaf spring of a comparison experiment example 2 is a corrugated leaf spring in which a curvature radius r of the curved surface part C is varied without changing the pitch P of the curved surface parts C and the height H in the corrugated leaf spring of the experiment example 1 (see FIG. 6C).

It is shown from FIG. 5 that h/h₀ of the corrugated leaf spring of the experiment example 1 decreases as compared with the corrugated leaf springs of the comparison experiment examples 1 and 2.

Note that fiber reinforced plastic other than the glass fiber reinforced plastic may be used. Examples of the fiber reinforced plastic other than the glass fiber reinforced plastic include carbon fiber reinforced plastic, although not particularly limited.

FIG. 7 shows relationship between r/r₀ and h/h₀ at a surface pressure of 2.5 MPa of the corrugated leaf spring.

It is shown from FIG. 7 that h/h₀ at a surface pressure of 2.5 MPa is decreased to 28% or less when r/r₀ is greater than or equal to 0.5 and less than or equal to 0.9.

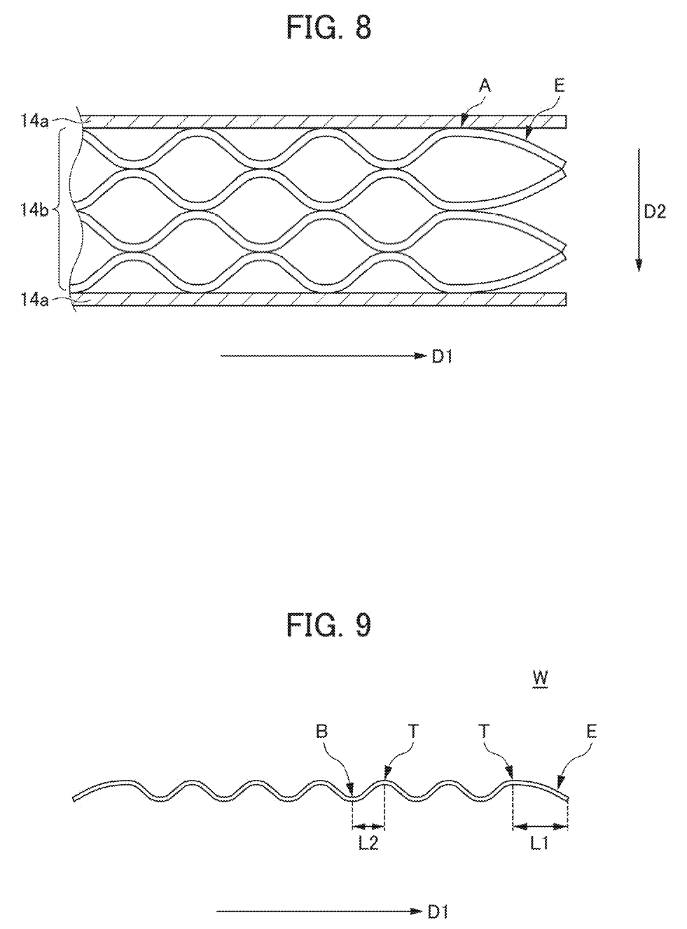

As described above, the second elastic member 14b is in contact with the first elastic member 14a at the plurality of contact areas A present in the width direction D1. The corrugated leaf spring W that contacts at the contact area A includes an extension E that extends outward in the width direction D1 from the contact area A present at each of outermost parts of the corrugated leaf spring W in the width direction D1 (see FIG. 8). In this case, as a distance in the width direction D1 from the contact area A present at the outermost part in the width direction D1 to the extension E increases, a distance in a thickness direction D2 from the first elastic member 14a that contacts at the contact area A to the extension E increases. Hence, when the elastic member 14 is compressed due to expansion of the battery cell 11a during charge, contact between the extension E and the battery cell 11a is suppressed, and, as a result of this, damage to the battery cell 11a is inhibited.

Note that the corrugated leaf spring W that contacts at the contact area A may include the extension E that extends outward in the width direction D1 from the contact area A present at one of the outermost parts in the width direction D1.

In the corrugated leaf spring W that contacts at the contact area A, a length L1 in the width direction D1 between a top T (or a bottom) of the curved surface part C adjacent to an end part of the extension E and the end part of the extension E is larger than a length L2 in the width direction D1 between a bottom B and a top T of the curved surface parts C adjacent to each other, as shown in FIG. 9. Consequently, hysteresis loss of the second elastic member 14b is reduced. In this case, a ratio of L1 to L2 is, for example, greater than or equal to 1 and less than or equal to 2, although not particularly limited. Further, L1 is, for example, greater than or equal to 5 mm and less than or equal to 20 mm, although not particularly limited.

The first elastic member 14a and the second elastic member 14b of the elastic member 14 are fixed to each other at the contact area A. Thus, intensity of the elastic member 14 is improved. A method for fixing the first elastic member 14a to the second elastic member 14b at the contact area A is, for example, a method of using an elastic adhesive to stick the first elastic member 14a and the second elastic member 14b together at the contact area A, although not particularly limited.

In contrast, the extension E of the corrugated leaf spring W that contacts at the contact area A is not fixed. Further, the corrugated leaf spring W that contacts at the contact area A is, in the extension E, separated from the adjacent corrugated leaf spring W. Consequently, hysteresis loss of the second elastic member 14b is reduced. In this case, a distance between end parts of the adjacent corrugated leaf springs W in the width direction D1 is, for example, greater than or equal to 0.1 mm and less than or equal to 1 mm, although not particularly limited.

Note that the number of stacked layers of the corrugated leaf springs W is not limited to four and may be any number satisfying 2N (note that N is a natural number). N is, for example, greater than or equal to 1 and less than or equal to 3, although not particularly limited. When N is greater than or equal to 2, a corrugated leaf spring W that does not contact at the contact area A includes an extension corresponding to the extension E included in the corrugated leaf spring W that contacts at the contact area A.

Note that, in the adjacent corrugated leaf springs W, the bottom of the curved surface part C and the top of the curved surface part C which face each other and are in contact with each other may be partly stuck together with, for example, an elastic adhesive.

The first elastic member 14a preferably has a Poisson's ratio of less than or equal to 0.3. When the first elastic member 14a has a Poisson's ratio of less than or equal to 0.3, the first elastic member 14a easily accommodates change in thickness due to expansion and contraction of the battery cell 11a. Note that the Poisson's ratio of the first elastic member 14a is, for example, greater than or equal to 0.

The first elastic member 14a when state of charge of the battery cell 11a is 100% has a thickness of, for example, greater than or equal to 0.05 mm and less than or equal to 0.1 mm, although not particularly limited.

The first elastic member 14a is, for example, a foam having a porosity of greater than or equal to 30% and less than or equal to 95%. Examples of a material that constitutes the foam include polyurethane, silicone resin, ethylene propylene rubber, styrene resin, olefin resin, polyamide, and polyester, although not particularly limited.

A material that constitutes the second elastic member 14b preferably has a Young's modulus of greater than or equal to 35 GPa. When the material that constitutes the second elastic member 14b has a Young's modulus of greater than or equal to 35 GPa, the second elastic member 14b easily accommodates change in thickness due to expansion and contraction of the battery cell 11a. Note that the Young's modulus of the material that constitutes the second elastic member 14b is, for example, less than or equal to 200 GPa.

Examples of a material that constitutes the second elastic member 14b include metal such as stainless steel and carbon steel, resin such as epoxy resin, phenolic resin, and nylon resin, and fiber reinforced plastic (FRP) such as carbon fiber reinforced plastic (CFRP) and glass fiber reinforced plastic (GFRP), although not particularly limited. Among these, FRP is preferable, and GFRP is particularly preferable, considering the energy density of the battery module 10.

The second elastic member 14b when the state of charge of the battery cell 11a is 100% has a thickness of, for example, greater than or equal to 1.0 mm and less than or equal to 1.2 mm, although not particularly limited.

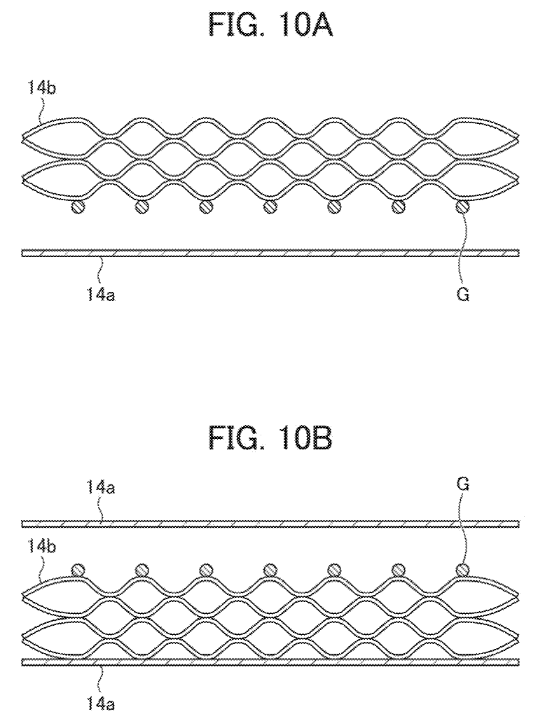

The following describes an example of a method for manufacturing the elastic member 14. First, a first elastic member 14a is obtained by foam molding. Meanwhile, a corrugated leaf spring W is shaped by press molding, and then, with the use of an elastic adhesive, adhesion is partly made between corrugated leaf springs W in which four layers are stacked, whereby a second elastic member 14b is obtained. Next, an elastic adhesive G is applied to a bottom of a lower curved surface part C of the second elastic member 14b, and then, the first elastic member 14a is placed (see FIG. 10A). In this case, pressurization may be performed concurrently with placing of the first elastic member 14a on the bottom of the lower curved surface part C of the second elastic member 14b, or after placing of the first elastic member 14a on the bottom of the lower curved surface part C of the second elastic member 14b. Next, the elastic adhesive G is applied to a top of an upper curved surface part C of the second elastic member 14b, and then, another first elastic member 14a is placed (see FIG. 10B). In this case, pressurization may be performed concurrently with placing of the first elastic member 14a on the top of the upper curved surface part C of the second elastic member 14b, or after placing of the first elastic member 14a on the top of the upper curved surface part C of the second elastic member 14b.

As a method for manufacturing the battery module 10 with the use of the elastic member 14, a known method can be used.

Examples of the battery cell 11a include solid-state battery cells such as semi-solid-state battery cells and all-solid-state battery cells, and electrolytic solution battery cells including negative electrode mixture layers containing lithium metal or a lithium alloy, although not particularly limited. Examples of an element that constitutes the lithium alloy except lithium include Sn, Ag, Mg, In, Si, and Al, although not particularly limited. Among these, the solid-state battery cells including negative electrode mixture layers containing lithium metal or a lithium alloy are preferable.

The following describes a case where the battery cell 11a is an all-solid-state lithium metal battery cell.

The all-solid-state lithium metal battery cell is formed by sequentially stacking, for example, a positive electrode current collector, a positive electrode mixture layer, a solid-state electrolyte layer, a lithium metal layer, and a negative electrode current collector.

Examples of the positive electrode current collector include aluminum foil, although not particularly limited.

The positive electrode mixture layer includes a positive electrode active material and may further include a solid-state electrolyte, a conductive additive, a binder, or the like.

The positive electrode active material is not particularly limited as long as lithium ions can be occluded and released, and examples of the positive electrode active material include LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂O₄, LiNiO₂, LiFePO₄, lithium sulfide, and sulfur.

The solid-state electrolyte that constitutes the solid-state electrolyte layer is not particularly limited as long as lithium ions can be conducted, and examples of the solid-state electrolyte include oxide-based electrolytes and sulfide-based electrolytes.

Examples of the negative electrode current collector include copper foil, although not particularly limited.

Although an embodiment of the present invention is described in the foregoing, the present invention is not limited to the embodiment disclosed and the embodiment may be changed as appropriate within the scope of the present invention.

### EXPLANATION OF REFERENCE NUMERALS

10 battery module

11 battery cell stack

11a battery cell

12 end plate

13 bind bar

14 elastic member

14a first elastic member

14b second elastic member

A contact area

E extension

W corrugated leaf spring

F flat surface part

C, C₀ curved surface part

B bottom

T top

G elastic adhesive

What is claimed is:

1. A battery module comprising:
a battery cell stack including a plurality of battery cells that are stacked together;
a pair of plate-shaped members provided on opposite ends of the battery cell stack in a stacking direction; and
an elastic member arranged between the plurality of battery cells and/or between the battery cell stack and the plate-shaped member,
wherein the elastic member comprises: a pair of first elastic members arranged on opposite outer sides of the battery cell stack in the stacking direction; and a second elastic member arranged between the pair of first elastic members,
wherein the second elastic member comprises 2N layers of corrugated leaf springs stacked in the stacking direction of the battery cell stack, N being a natural number,
wherein the corrugated leaf spring comprises curved surface parts contiguously arranged with a flat surface part therebetween, and extends in a predetermined direction, the curved surface parts having an identical curvature radius,
wherein the flat surface part has a surface approximately parallel to a tangent plane in an end part of the curved surface part, the end part being arranged contiguous to the flat surface part, and
wherein, provided that the curved surface parts each have a curvature radius of r [mm], and that, when a pitch of the curved surface parts and a height are not changed in the corrugated leaf spring and the curved surface parts having an identical curvature radius are alternately and contiguously arranged without the flat surface part therebetween, the curved surface parts each have a curvature radius of r₀ [mm], the following formula is satisfied:
10.50≤r/r₀0≤.90.

2. The battery module according to claim 1, wherein the following formula is satisfied:
20.60≤r/r₀0≤.85.

3. The battery module according to claim 2, wherein the following formula is satisfied:
30.70≤r/r₀0≤.80.

4. The battery module according to claim 1,
wherein the second elastic member is in contact with the first elastic member at a plurality of contact areas present in a width direction,
wherein the corrugated leaf spring contacting at the contact areas comprises an extension extending outward in the width direction from the contact area present at an outermost part of the corrugated leaf spring in the width direction, and
wherein, as a distance in the width direction from the contact area present at the outermost part in the width direction to the extension increases, a distance in a thickness direction from the first elastic member contacting at the contact area to the extension increases.

5. The battery module according to claim 4, wherein
in the corrugated leaf spring contacting at the contact areas, a length in the width direction between a top or a bottom of the curved surface part adjacent to an end part of the extension and the end part of the extension is larger than a length in the width direction between a bottom and a top of the curved surface parts adjacent to each other.

6. The battery module according to claim 1, wherein the corrugated leaf spring comprises fiber reinforced plastic.

7. The battery module according to claim 1, wherein the battery cells are solid-state battery cells.

8. The battery module according to claim 1, wherein the battery cells comprise a negative electrode mixture layer containing lithium metal or a lithium alloy.
